(19) United States
(12) Patent Application Publication
(10) Pub. No.: US 2005/0114361 A1
(43) Pub. Date: May 26, 2005

(54) Method and apparatus for integrating data repositories and frameworks

(76) Inventors: Brent Roberts, St. Peters, MO (US); Todd Mayfield, St. Peters, MO (US); Jeannine McConnell, Troy, MO (US); Eric Burke, O'Fallon, MO (US)

Correspondence Address: BLACKWELL SANDERS PEPER MARTIN LLP, 720 OLIVE STREET, SUITE 2400, ST. LOUIS, MO, 63101, US

(21) Appl. No.: 10/722,630

(22) Filed: Nov. 26, 2003

(51) Int. Cl. G06F 17/00; G06F 17/30

(52) U.S. Cl. 707/100; 707/1; 707/2; 707/3; 707/4; 707/104.1; 707/102

(57) ABSTRACT

An apparatus and method for integrated macro-frameworks that can be called by the object oriented software code to provide a consistent and efficient graphical presentation. The frameworks are macro-functions that can be utilized by various applications and are such that within each application and from application to application there is a consistency in the presentation of information and how information is entered and retrieved. The frameworks also provide for efficient operations of the application as well as efficient access of database tables. The frameworks can also provide an efficient and consistent means for developing a graphical user interface navigation function for navigating through various screens of a given application.

### BACKGROUND OF INVENTION

1. Field of Invention

This invention relates generally to processing information in a client-server environment for a graphical user interface and, more particularly, to tool sets, data repositories and frameworks for facilitating development and operation of object oriented applications for generating graphical presentations at the client.

2. Background Art

Older conventional software programming methodology utilized a top/down procedural approach. This methodology developed software with a top/down flow that proceeds from the beginning to the end in a straight line with calls to branch procedures along the straight line flow for performing specific functions and then returning to the straight line path. Usually there was a hierarchy of functions from the top level executive program to the branch and sub branch routines. Code that was reusable was placed into procedures and functions, which are then used by other procedures, functions or mainline executive code.

This older conventional methodology paradigm, however, began to shift as larger more complex software applications were developed that provide graphical user interfaces (GUIs). When utilizing the older methodology, these more complex applications required so many side calls along branches and sub branches that the software became convoluted. In addition the branch or sub branch general purpose routines may or may not satisfy the functional requirements of the calling routine. Also, the developer would have to have intimate knowledge of a branch or sub-branch in order to use it effectively. To address this problem, a paradigm shift has been made to object oriented techniques, where the reusable code is more extensible. The object oriented technique makes the software development more manageable and makes the turn around on software modifications much shorter.

The object oriented technique or methodology revolves around what is referred to as an “object”. Objects provide reusable data manipulation functionality along with reusable data, or more specifically reusable data types. Much of a software applications functionality and intelligence can be contained within objects, therefore the software developer can devote more time developing the code for sending, receiving and responding to messages transferred among objects than developing detailed code that is contained in the object. The objects are encapsulated such that the programmer can manipulate the objects without accessing or understanding the internal functionality, structure or data. While the internal workings of the object may be accessible, access is not necessary to effectively use and manipulate the object. The software developer does not have to write code to handle an object's data manipulation requirements. The developer is only required to reference the object method that manipulates the data. The object oriented paradigm enables the software developer to add to, modify or delete parts for the new object that differ from the original object.

The shift in the paradigm toward object oriented methodology has resulted in newer object oriented software languages being developed, one of which is Java. Sun Microsystems developed Java to address software distribution and operational issues on the internet. Java is an object oriented language, which supports multi-function or multi-thread processing, where the thread or function can be executed independently from the over all program. Java is based on C++, but is a much more basic higher level language. Java programs are compiled into a binary format that can be executed on many different platforms without having to be recompiled. A typical Java development tool will include a language specification; a Java compiler, which produces byte-codes; a virtual machine program that interprets the byte-codes at run time; a set of class libraries; byte-code verification at runtime and multi-threading; byte-code disassembler; and a browser.

Java is designed for creating applications that will be deployed in heterogeneous networked environments. Such environments are characterized by a variety of hardware architectures. To accommodate such diversity, the Java compiler compiles platform-neutral byte-codes that are compatible in multiple platform environments and architectures, which creates an intermediate format designed for deploying application code efficiently to multiple platforms. This allows Java to be utilized with various different operating systems and to interface with various software language interfaces.

Java byte-codes can easily be interpreted on any machine. Byte-codes are essentially high-level, machine-independent instructions for a hypothetical or “virtual” machine that is implemented by the Java interpreter and runtime system. The virtual machine, which is actually a specification of an abstract machine for which a Java language compiler generates byte-code, must be available for the various hardware/software platforms which an application is to run. The Java interpreter executes Java byte-code directly on any machine for which the interpreter and runtime system of Java have been ported. In this manner, the same Java language byte-code runs on any platform supported by Java.

The compiling of Java into platform-neutral byte-codes makes Java a very portable and powerful development language to meet the needs of an object oriented paradigm.

If the Java language interpreter and runtime support are available on a given hardware and operating system platform, any Java language application can be executed. The byte-codes are portable since they do not require a particular processor, architecture, or other proprietary hardware support. Further, the byte-codes are byte-order independent, so that programs can be executed on both your standard Intel architecture machine and your standard Motorola architecture machine. Java byte-codes are segregated by type, where each byte-code specifies the exact type of its operands, thereby allowing verification that the byte-codes obey language constraints.

The byte-codes are stored in “class” files. Each class file stores all the information for a particular Java class. A “class” in Java is a software construct, which defines instance variables and methods, in effect, serving as a template for creating objects of a particular type. A Java class is similar to a C++ class. The objects method manipulates the objects data or its instance variables. Objects communicate between one and another by sending and responding to messages, which invoke methods appropriate for responding to the message and performing any necessary data manipulation.

Various software development tools have been created to assist development in Java or other object oriented languages. The development tools provide an integrated development environment. The development environment usually includes a form or template for defining the attributes and properties of the objects. The tool also enables the developer to attach or associate program code to an object. Usually an editor is provided for editing the program code. These developmental tools however do not relieve the developer of the task of writing the detailed code, particularly the detailed code required for a complex graphical user interface application.

In order for a software developer to implement a complex graphical user interface utilizing Java or another comparable language, the developer must write detailed code for navigation from screen to screen; defining data fields; binding data; screen format; and etc. . . . Therefore, when changes are required for the display presentation or graphical user interface, a significant amount of code has to be rewritten or as a minimum the software developer must be concerned with making sure that existing code will satisfy all his requirements. Further, when similar applications are being developed the developer must be concerned about the details of existing code to determine if the existing code meets the developers requirements.

Many times applications are developed and the applications are modified to develop new applications or many times a suite of integrated applications are developed and there is a desire to maintain a consistent look and feel between the applications. Existing software development tools for Java or like languages do not satisfy these requirements. Some developers have attempted to utilize tables that contain data or information about other data, and within the written program are commands referencing these tables such that the tables can be updated without updating the program. This method is helpful for software languages such as visual basics, but does not provide a more integrated and comprehensive solution as required for object oriented languages like Java and other like languages. A more comprehensive solution is required to address the above issues.

### BRIEF SUMMARY OF INVENTION

The present invention is a system environment where frameworks are utilized in a typical client-server network environment where object oriented code such as JAVA is used to generate user interface screens where a user can retrieve and view data as well as input data. Typically object oriented software languages such as JAVA is utilized to present screens. Also an object oriented architecture is often utilized. However, in order to generate and display typical user interface screens, a detailed code must be developed including developing syntax, format, field definition, placement on screen, navigation from screen to screen and other graphical details. The present invention alleviates the developer of the responsibility of generating such detailed code by providing an integrated system of frameworks comprising a User Interface (UI) Repository Framework; a Data Binding Repository Framework; a Screen Repository Framework; and a Navigation Framework.

The present invention involves integrated macro-frameworks that can be called by the object oriented software code to provide a consistent and efficient graphical presentation. The frameworks are macro-functions including integrated respositories that can be utilized by various applications and are such that within each application and from application to application there is a consistency in the presentation of information and how information is entered and retrieved. The frameworks also provide for efficient operations of the application as well as efficient access of database tables. The frameworks can also provide an efficient and consistent means for developing a graphical user interface navigation function for navigating through various screens of a given application.

One category of frameworks within the integrated system of frameworks is the repository of defined data fields or UI Repository. The defined data field repository framework is a repository of macro-frameworks or UI element attribute tables, which define data fields and their sizes, labels, masking, syntax, and all other field related definitions that are required to present data fields on a user interface screen page. The object oriented code would simply have to call the framework from the repository and define the data to be retrieved and input in the field and the remainder of the graphical presentation is handled by the framework and this provides for efficient and consistent presentation of data field, as well as consistent retrieval and input of data for the graphical presentation.

Another type of framework utilized in the system of integrated frameworks is the data-binding framework. The data-binding framework is a macro-framework or macro-instruction that can be called by the object oriented code in order to call a predetermined category or a set of data and bind the data together in a specific format with a UI element such that the data can be manipulated efficiently and can also be provided for a graphical presentation.

Yet another framework that is within the system of integrated frameworks is the navigation framework. The navigation framework is a macro-framework of navigation nodes and sub-nodes that can be selected allowing the user to navigate through an application. The navigation framework initiates data retrieval and recalls other frameworks for creating a graphical presentation corresponding to the node selection. The Framework defines a navigation scheme and defines what selection of a given node or sub-node will provide. The nodes and sub-nodes can be rearranged within the limitation of the Framework. The Navigation Framework contains macro instructions which define a node's detailed operation when selected. A software developer does not have write navigation code, but can simply call the navigation framework. The Navigation Framework provides efficient and consistent navigation through an application.

Yet another type of framework in the integrated system of frameworks is the screen repository framework which is a set of macro-frameworks which define the format of the various elements being presented in the active graphical screen. This framework is a macro-function or collection screen class attribute tables that can be called by a application for creating an active screen that is consistent with all other screen formats and efficiently utilizes other frameworks to generate the graphical presentation. The screen repository framework can also include frameworks that control button functions that may alter the appearance of the active screen. The screen repository also allows for association between the navigation macro and the other content macros.

The various frameworks are integrated together such that they can be readily called by an application to provide an integrated and consistent graphical presentation. The integrated system of macro-functions or frameworks provide an integrated tool for implementing object oriented code to generate active sever pages. The frameworks provide for consistency and efficiency and provide a consistent look and feel for the user. The object oriented code calls and executes the framework rather than having detailed source code written for each task. The integrated system of frameworks also includes administrative tool sets for building the repositories and Navigation scheme.

The integration of the repositories are driven off and revolve around Logical types. The logical types drive various factories or engines within applications utilizing the present invention, such as a Document Factory, a Component Factory, and a Morper Factory. The User Interface (UI) elements also build off the logical types. For example, the Component factory in a billing software application will require a field definition for data field referred to as “Amount Due”. The XML file for defining and generating the screen layout will execute a server call for retrieving a data object. The server call for the data object contains a reference field for Amount Due. A data binding repository is utilized for importing data for Amount Due into the data object. The data binding repository is a way for the software developer to send data across the network and get data from a data base and import the data into the data object. The data binding repository will refer to a UI element, for example, Amount Due. The Data Binding function will bind the data component with the UI element.

The UI element comprises a table of attributes including a logical type definition, such as Type-Currency, which refers to a program written in Java or like application for the type Type-Currency. The program, when executed, provides the behavior and functionality of the field for Amount Due. As a user interfaces with the user interface screen, the Java program code for currency is executed. For example, if the user enters data into the field, the data object can be updated dynamically and the data base can be updated with the entered value.

The UI repository framework comprises a plurality of UI Element attribute tables that are global and not specific to a particular screen. This provides a great advantage over relational tables that are screen specific or related to a particular form or document. The screens for the user interface are not built directly from the tables, which would limit flexibility. The screens are coded by the developer as they physically define the components that appear on the screen and control their layout via a specified XML file. Further, the present invention does not require a database to store the attribute tables at a customer user site. The repositories are extracted to an XML format and shipped with the software and loaded into memory as the application loads. This eliminates any need for network traffic as data is loaded.

The Screen Repository comprises an inventory of screens for every navigation node of the drill-down menu and every other navigation selection means. The Screen Repository element is an attribute table comprising Application Name, Screen Name, Level (whether branch or leaf); and screen class, which refers to Java code that runs dynamically at run time. An XML file is generated, which defines the element behavior on the screen. Each element on the screen corresponds to an element in the UI repository. Every screen that can be accessed corresponds to a screen in the Screen Repository. As a user navigates through the application and selects a screen, a screen ID in the screen repository is invoked. When a screen is selected by a user by clicking on a node or otherwise selecting a screen, the screen ID or name of the screen element of the repository is invoked.

The Navigation framework is integrated with the repositories to provide functionality allowing the user to navigate to the various screens. The user, utilizing the navigation framework, can navigate to a screen various different ways such as selecting a node, selecting a favorite that was previously set up; or selecting a hyperlink. The navigation framework defines the object types and the basic screen layout. When an application is launched, the Navigation Framework invokes the basic screen. The user can then select other screen options. The navigation framework also keeps track of where a user has navigated, such that the user can page backward and forwards through previously selected screens.

The Frameworks are combined to provide a consistent look and feel for the user; and the frameworks are an effective software development tool. Each of the screens within an application can, for example, have a content panel area, a navigation area or a hierarchy of drill down nodes and sub-nodes; and other user interface specific areas. In the content panel area, all the data fields can be generated by called and executed frameworks. When a selection is made that requires a different screen, a framework from the screen repository is called and executed and is integrated with the navigation framework, data field repository framework, and data binding repository framework to generate the final user interface screen. The integrated system of frameworks relieves the software developer of the need to write detailed code or be concerned about the details of existing code. The developer can utilize the integrated system of frameworks to develop new applications while maintaining a consistent look and feel. The primary reason for the integrated system of frameworks is to reduce the coding complexity for application developers when writing distributed Java applications using a sophisticated graphical user interface. The application developer does not need to write the tedious and error-prone code of handling data received from the application server and appropriately displaying the data on the screen. Security issues are handled automatically, i.e. screens disappear from the left navigation tree structure, buttons disable, etc., without the application programmer having to code anything. Most data updating and GUI event handling is accomplished by the frameworks requiring considerably less code per screen. The GUI components handle the proper displaying of data based on the properties in the UI element repository and only accept the proper data based on the element's type saving considerable coding by the application developer. These frameworks provide for consistent behavior with considerably less errors and significantly less code to develop an application. These and other advantageous features of the present invention will be in part apparent and in part pointed out herein below.

### BRIEF DESCRIPTION OF THE DRAWINGS

For a better understanding of the present invention, reference may be made to the accompanying drawings in which:

FIG. 1 is function diagram of a client-server environment implementing a graphical user interface;

FIG. 2 is functional diagram depicting the interfaces and interrelationship between the frameworks;

FIG. 3 is a functional diagram showing the data structure and interrelationship between the UI repository and the Data binding framework and the program code for UI element type;

FIG. 3a is a screen from the UI repository tool set;

FIG. 3b is a functional diagram showing the administrative tool function of building the repositories;

FIG. 3c is a functional diagram showing the administrative tool function for building navigation function and repositories;

FIG. 4 is a functional diagram showing the interrelationship between the Screen repository and the Navigation framework;

FIG. 4a is a screen from the Navigation framework administrative tool.

FIG. 5 is a screen shot reflecting a basic graphical user interface that can be generated by frameworks;

FIG. 6 is a functional flow diagram of the integrated frameworks operation at the software code level;

FIG. 6a is a functional flow diagram of the tool for building the frameworks;

FIG. 6a is a function flow diagram of the frameworks administrative tool;

FIG. 7a is a sample screen that can be generated utilizing frameworks;

FIG. 7b is a sample screen that can be generated utilizing frameworks;

FIG. 8 is a hypothetical example of a basis left navigation and basic screen utilized to illustrate integration of the frameworks; and

FIG. 8a is a functional flow diagram of the integrated frameworks operation at the framework/repository level.

### DETAILED DESCRIPTION OF INVENTION

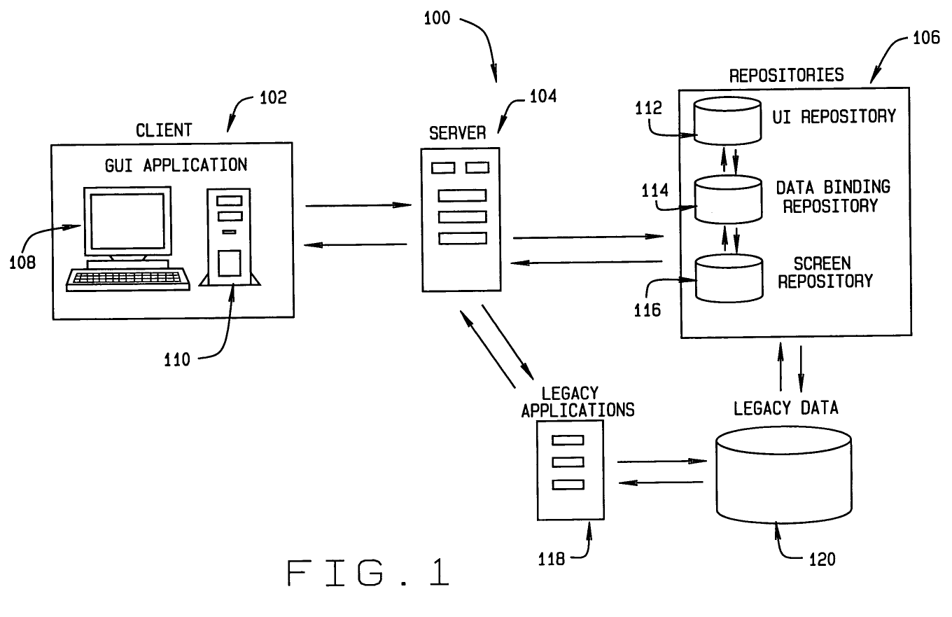

According to the embodiment(s) of the present invention, various views are illustrated in FIGS. 1-8 and like reference numerals are being used consistently throughout to refer to like and corresponding parts of the invention for all of the various views and figures of the drawing. Also, please note that the first digit(s) of the reference number for a given item or part of the invention should correspond to the Fig. number in which the item or part is first identified.

One embodiment of the present invention comprising a UI Repository Framework, a Data Binding Repository Framework, a Screen Repository Framework, and a Navigation Framework integrated to form a graphical user interface framework, which teaches a novel apparatus and method for generating a complex graphical user interface.

The navigation framework defines the basic screen layout, the navigation logic, and keeps track of where a user has navigated. The navigation framework invokes a basic screen. The navigation framework responds to a navigation selection type (selecting a node, selecting a hyperlink, and etc. . . . ) and refers to a screen element attribute table in the screen repository. The table defines several functional attributes such as the top level software application name, the screen name, the level relationship (branch, leaf, sub leaf, and etc. . . . ), and the screen class. The screen class refers to Java code for generating the screen, which is executed dynamically at run time. An XML file is generated, which defines the layout of the screen. For example, a component factory will be executed, which will need a field such as Amount Due. A server call will be executed to retrieve the appropriate data object. The data object has a field identifying Amount Due correlating to a data repository element, which imports the data into the object. Then a UI repository element for Amount Due is accessed identifying a logical type such as Type-Currency, which correlates to Java program code. The Java code for Type-Currency, when executed, provides for the behavior and functionality of the data field. The data field and functional characteristics are provided back to the screen Repository function for inclusion in a screen. The data objects are updated as necessary depending on the user entries and selections.

The repositories off of Logical Types, which define the physical Java type, pattern, mask, and length. The logical types drive various factories within a typical graphical user interface application such as a: Document Factory, Component Factory, and a Morper Factory. A UI Element then builds off of the Logical Types. The invention is not simply a meta-data table, which defines elements on a per form basis. The present inventions UI Element attribute tables are global, and not specific to a screen or form. A UI Element also encompasses various categories of labels (which support long and column). The present invention provides the ability to give specific screen attributes such as patterns, labels, editing, online help for the field, as well as the ability to override attributes defined by its logical type. There are no hard coded dependencies in the Java code between the screens. The screen repository function can override and drive a UI elements function on the screen. The present invention also offers the ability to give screen specific attributes, for the help, pattern, labels and editing option. The TmaResultSet, a master data model, drives off of the UI Element information. It ensures that any data attempted to be stored in the model passes all the requirements of the UI Element.

The present invention does not require a database to store the UI Element attribute table information at a customer site. The present invention's repositories are extracted to an XML format and shipped with the software and loaded into memory as the graphical user interface, which will define the elements behavior on screen as the application loads. This eliminates any need for network traffic as UI Element information is loaded.

The present invention does not build the screens from the UI Element information. The present invention does not merely specify the columns and their order on a specific screen and the screen is not simply built dynamically from the table. The present inventions screens can be hand coded by developers, as they physically define the components that appear on the screen and control their layout via a specified XML file, which generally is one XML file per main panel. The present invention does not simply trigger from a tree structure as defined which then accesses information in the UI Element table to build the screen. The present invention does have a tree or a navigator definition that ties to a Java implementation class or report, but not to any other attribute table. The present invention provides considerable flexibility.

The details of the invention and various embodiments can be better understood by referring to the figures of the drawing. Referring to FIG. 1, a functional diagram of a typical client-server environment 100 implementing a graphical user interface is shown. A typical client 102 is shown interfacing with a typical server function 104. The server 104 interfaces with a bank of repositories 106. The bank of repositories includes a user interface (UI) repository 112, a Data Binding Repository 114 and a Screen Repository 116. The server and repository functions interface with legacy application 118 and a legacy database 120.

The graphical user interface applications 110 are shown resident at the client site. The user interface 108 provides graphical user interface screens as well as a data entry capability. The integrated repositories 106 allow the graphical user interface application 110 to run more efficiently and provide a rich graphical presentation having a consistent look and feel. The graphical user interface application is also able to interface to various legacy applications and legacy databases by utilizing the integrated repositories to provide much of a data handling functionality. The various repositories are linked to various object oriented applications that execute at run time to perform much of the data binding and field definition functions as well as screen arrangement. The graphical user interface application triggers execution of the repository functionality as well as imports data and graphical information in order to generate the graphical user interface.

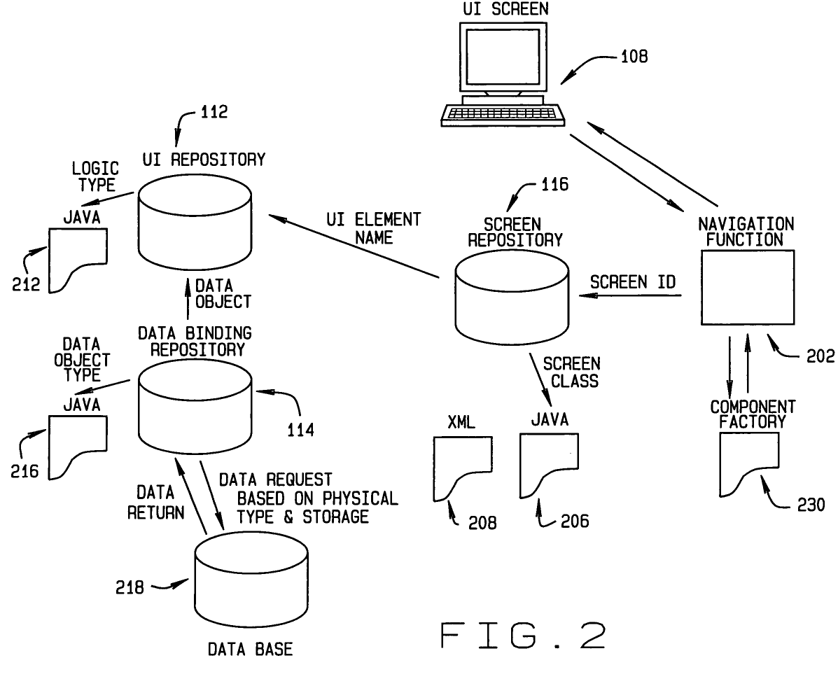

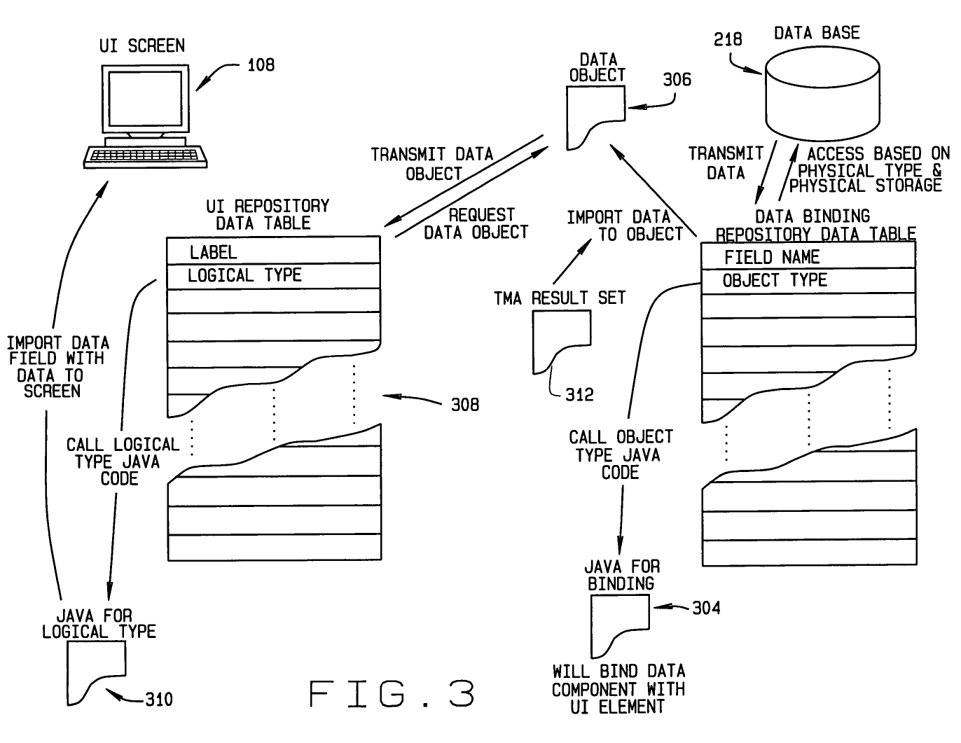

Referring to FIG. 2, a functional diagram depicting the interfaces and interrelationship between the frameworks is shown. Each of the repositories create what can be referred to as a framework such as a User Interface (UI) framework, a Data Binding framework, and a Screen framework. In addition to the repository frameworks, the present invention includes a navigation framework. The navigation function 202 is shown interfacing with the screen repository framework 116. The screen repository framework 116 in turn is communicably linked to the UI framework and the data binding framework. The integrated frameworks are communicably linked to a database function 218. The UI repository 112 is communicably linked to execute logic type java code 212 for controlling the functionality and operation of the data object field. The data binding repository 114 is linked to execute java code relating to the data object type for binding data retrieved from a database 218 and importing data into the data object. The screen repository identifies the UI element to be graphically presented by the UI element name. The screen repository is linked to execute screen class java code for generating a given screen class and relating the screen class to one or more UI elements.

The repositories are extracted to an XML format and shipped with the application software and loaded as a graphical user interface. The screen repository framework retrieves the GUI Component based on the UI Element repository and binds the GUI Component to the XML Layout Manager. The Layout Manager reads the screen frameworks XML file and lays out the GUI Component on the screen.

The screen repository defines the hierarchical structure of the left navigation tree for an application and determines the Java class that will be constructed and executed when a node is selected in the tree. This allows the navigation of the application to be structured as needed by the designers and not hard-coded within the application. Search panels are associated to the screens within the repository so that the search panels can be developed independent of the screen, easily reused and changed. A screen repository tool developed in Java is an application within the present invention that is used to maintain the screen repository database tables. An XML file is created at build time from the database tables that is used by the navigation and security frameworks.

The screen repository function generates an XML file 208 for the graphical interface during run time. The navigation function 202 of the present invention initiates the generation of a given screen by identifying the screen id. The navigation framework controls the displaying of the screens within an application. It builds the left navigation tree structure based on the screen repository XML file. The framework allows for quick jumping between screens and controls the displaying of screens within the application's entity navigator window or within a dialog. The framework controls the state of the common buttons, which provides for consistent behavior between screens. This framework also controls the screen state that indicates if there is data available to display by the GUI components. The GUI components are notified of the screen state and their display states are set accordingly.

The UI repository function identifies a logic type based on the screen id selected by the navigation function. The logic types drive various factories within the software for example the component factory 220. The UI Repository 112 is accessed by identifying a UI element. The UI element identified will further identify a Logic Type attribute, which is associated with executable JAVA code. The Java code when executed will control the functionality of the UI element.

The UI element repository defines how the data-binding framework will handle the data and how the data will be displayed on the screen by the GUI components. Labels, tool tips, one line help, etc. are types of information that is contained in this repository. Data types, i.e. date, currency, text, etc., are defined and associated to elements. An element represents a piece of data that is used by the application. The data types dictate the acceptable data that can be entered into the GUI components. Display attributes control how the data is displayed within the GUI component.

A UI repository tool developed in Java is an application in the present invention that is used to maintain the UI element repository database tables. An XML file is created at build time from the database tables, which is used by the data binding and GUI frameworks.

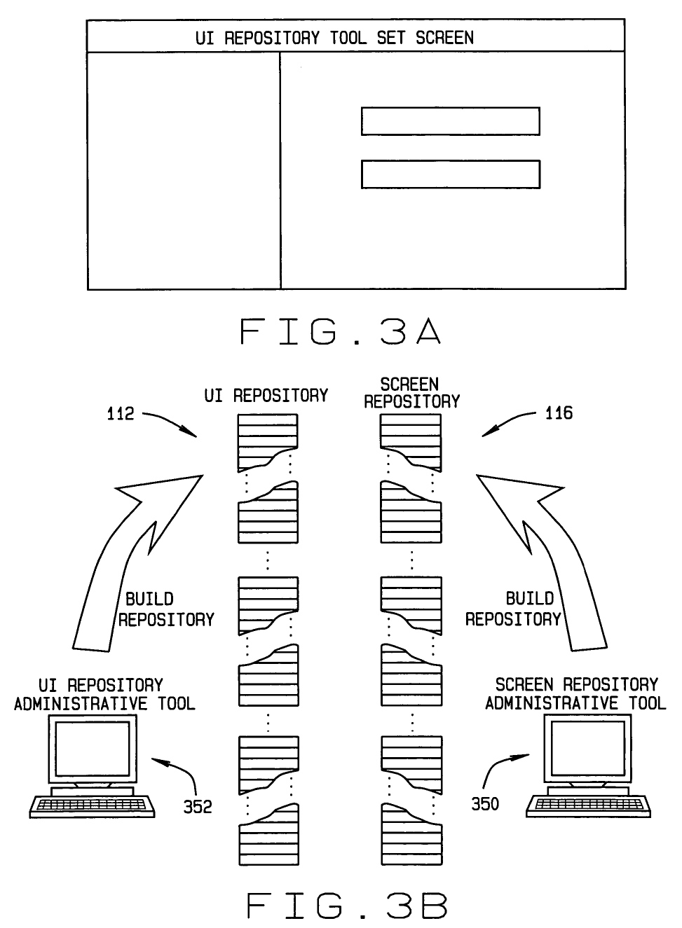

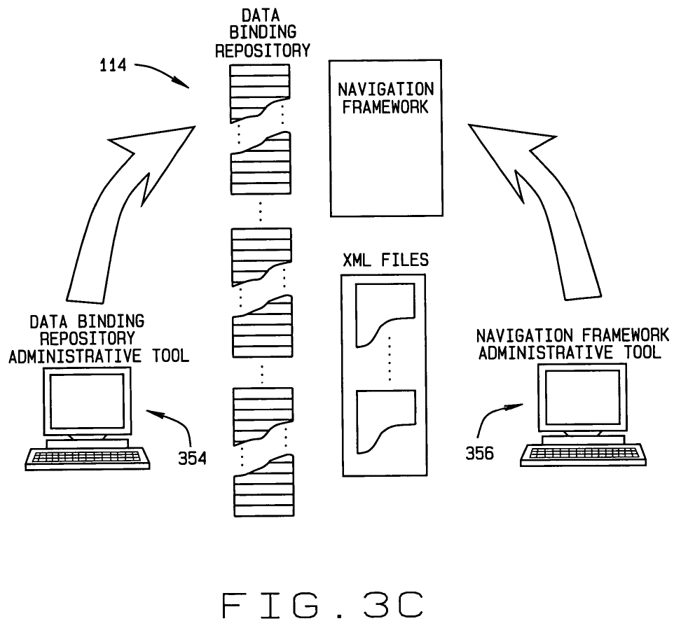

Referring to FIG. 3, a functional diagram showing the data structure and interrelationship between the UI repository and the Data binding framework and the program code for UI element type is shown. The UI repository data table 308 and the data binding repository data table 302 that are shown are intended to be representative of the data structure of a UI element data table in the UI repository and a Data Binding Attribute Table in the data binding repository. The data binding repository data table 302 is shown and is representative of the data structure of an element in the data binding repository. The data-binding framework binds data received from the application server to UI elements and GUI components. The application developer binds a GUI component to a UI element contained within a data set. This binding provides for communication between the data sets and the GUI components. This communication keeps the two synchronized so as the user enters new data into a GUI component the associated data set is updated. Also, as a data set is changed via the application the GUI components will be updated.

As discussed in FIG. 2, the data repositories and more specifically the data repository tables are linked to executable java code for performing the binding function 304 as well as the java for logical type 310. The java code is executed at run time and the repository information is exported to an XML file. The Tma Result Set 312, a master date model, drives off the UI element information. It assures that any data attempted to be stored passes all requirements of the UI element.

In addition to the above frameworks the GUI framework controls how data is displayed and processed within a GUI component. A GUI component is bound to an element from the UI element repository, which dictates the type of data allowed and how the data will be displayed. The GUI component is bound to a data set using the data-binding framework to control how the data is set upon the component and how the data set is updated by the component.

An XML layout manager determines the screen layout definition from an XML file instead of hard-coding the layout within the Java class. This allows for dynamic changes by the application developer to the screen layout as the application is running to provide the ability to fine-tune the placement of the GUI components on the screen.

Optionally the invention can include a security framework and a verification framework. The security framework controls the display of the login dialog accepting the user id, password and company to authenticate. The left navigation tree structure is filtered to only show the screens that are authorized for the user. The common buttons are shown or hidden based on the level of access granted to the user. An administration screen allows authorized users to set up roles and users for access to an application.

The verification framework provides for standard and custom verifiers to be applied to a data set. Application developers write verifiers applying the business rules for the data. If a verifier determines that the data is in error, the bound GUI component is notified to display the error message and render the data in the standard error format. The application server business object attaches the needed verifiers to the data sets returned to the client so that the client and server remain in sync concerning verification.

Referring to FIG. 3a, a screen from the UI repository tool set is shown. Shown is a representative Screen for the UI repository tool set which allows the application administrator to build the UI repositories. An application administrator will utilize this tool set to build the UI repository attribute table. A functional diagram of the Administrator tool set is shown in FIGS. 3b and 3c. The UI repository administrative tool 352 and the screen repository administrative tool 350 are utilized to build the repositories 112 and 116. The administrative tools 354 and 356 are utilized to building a data binding repository and the navigation frameworks.

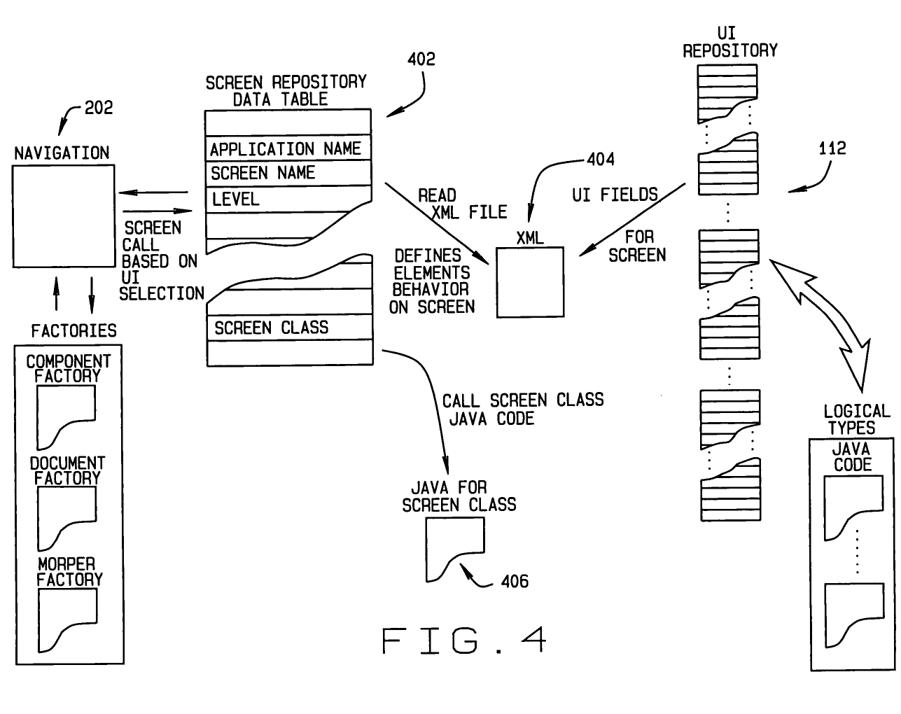

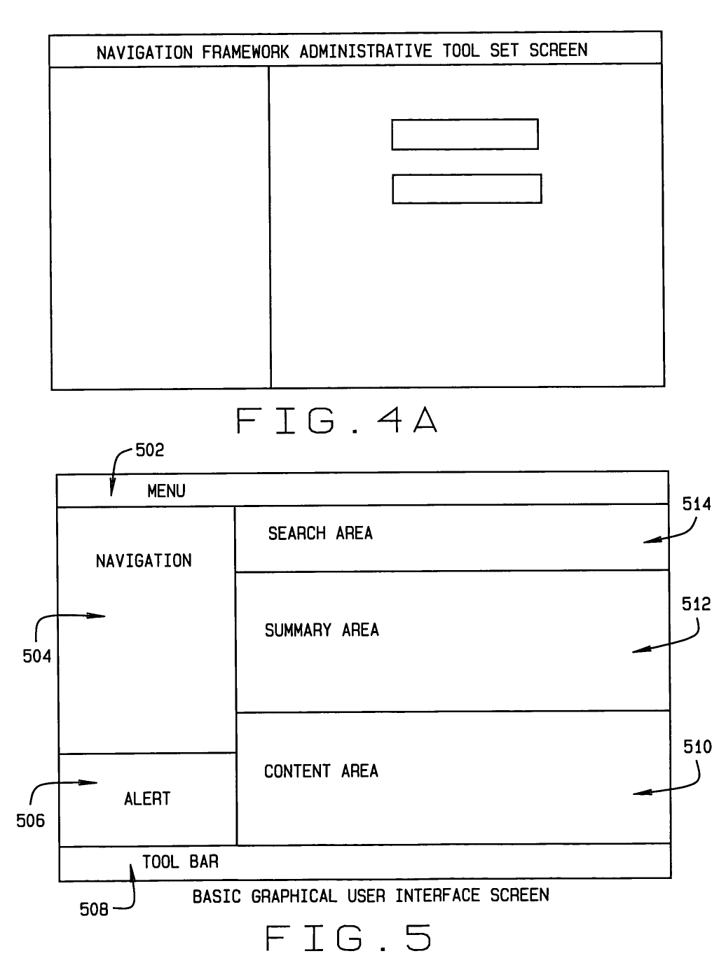

Referring to FIG. 4, a functional diagram showing the interrelationship between the Screen repository and the Navigation framework is shown. The screen repository data table 402 as shown is a representative of the data structure of the attribute elements contained within the screen repository function. The navigation function 202 identifies the appropriate user interface selection for correlating to a given screen repository attribute table. The screen repository data table function will call the screen class java code for execution of a given screen class which ultimately generates an XML file 404, which packages various UI fields for the screen as received from the java repository function 112. The screen repository attribute data table identifies the application name that is currently running at the client site as well as the screen name that has been called and the level of the screen within the hierarchy. The attribute table also identifies the screen class of java code to be executed in order to control the function of a given screen. The screen level defines the tree level in relation to the other screens within the tree hierarchy.

Referring to FIG. 4a, a screen from the Navigation framework administrative tool is shown. The screen shown is representative of a screen shot within the Navigation framework administrative tool which allows the application administrator to define the screen tree hierarchy as well as define other navigation functionality. Within this administrative tool set function, the application administrator can define how each screen is accessed, whether through a tree hierarchy or through the various jump to or hyperlink functionality.

FIG. 5 is a screen shot reflecting a basic graphical user interface that can be generated by the integrated frameworks. This screen shot is representative of a typical graphical user interface screen that can be generated, utilizing the integrated frameworks. The graphical user interface can include a menu 502 navigation functions 504, alerts 506 and tool bars 508. The graphical user interface application utilizing frameworks can also provide a comprehensive search area 514 a summary area 512 and a content area 510.

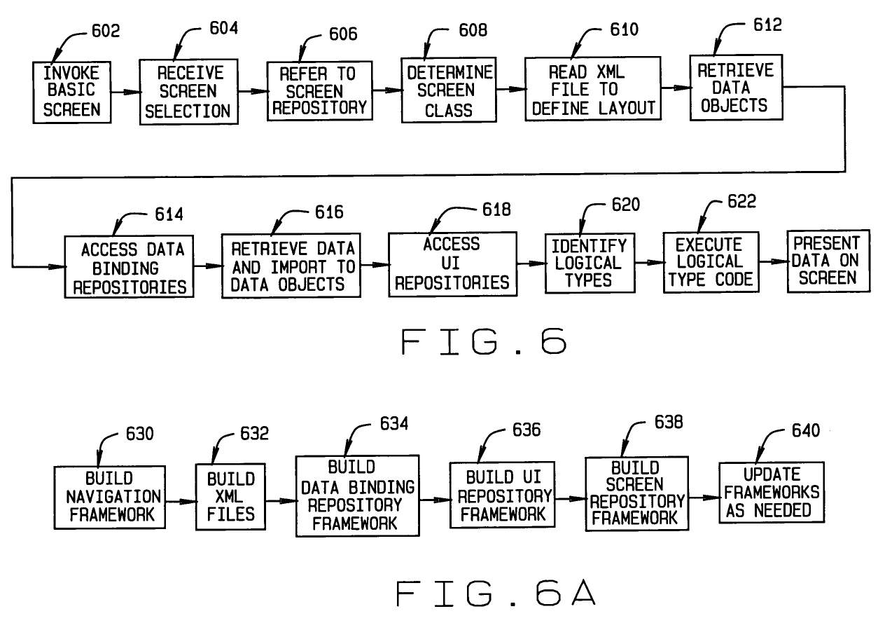

Referring to FIG. 6, a functional flow diagram is shown for generating a graphical user interface. Through some navigation function initiated by the user, the step of invoking a basic screen 602 is performed. The application receives the screen selection as represented by functional step 604 and the screen selection initiates the referencing to a screen repository as reflected by step 606. Once the screen repository has been referenced the screen repository function will determine the screen class to be executed as represented by functional step 608. The screen repository function will read an XML file to define the layout of the screen as indicated by functional step 610. The appropriate data objects for generating a screen as reflected by functional step 612 is subsequently performed. The data binding repositories are then accessed as represented by functional step 614 where the data is retrieved and imported in data objects as reflected by functional step 616. The UI repositories are then accessed as represented by functional block 618 which identifies a logical type as identifying functional block 620. The logical type java code is executed as represented by functional step 622 which provides the various data fields and locations for a given screen. The logical types can drive the various application's factories utilizing the above logic flow.

Referring to FIG. 6a, a flow for utilizing the Administrative Tools is shown. By utilizing the administrative tools as reflected in FIGS. 3a and 3b, an administrator can perform the functional flow as outlined in FIG. 6a. The administrator can build the various frameworks and XML files as reflected by functional blocks 630, 632, 634, 636, 638. Also, the administrator can edit or update the frameworks 640.

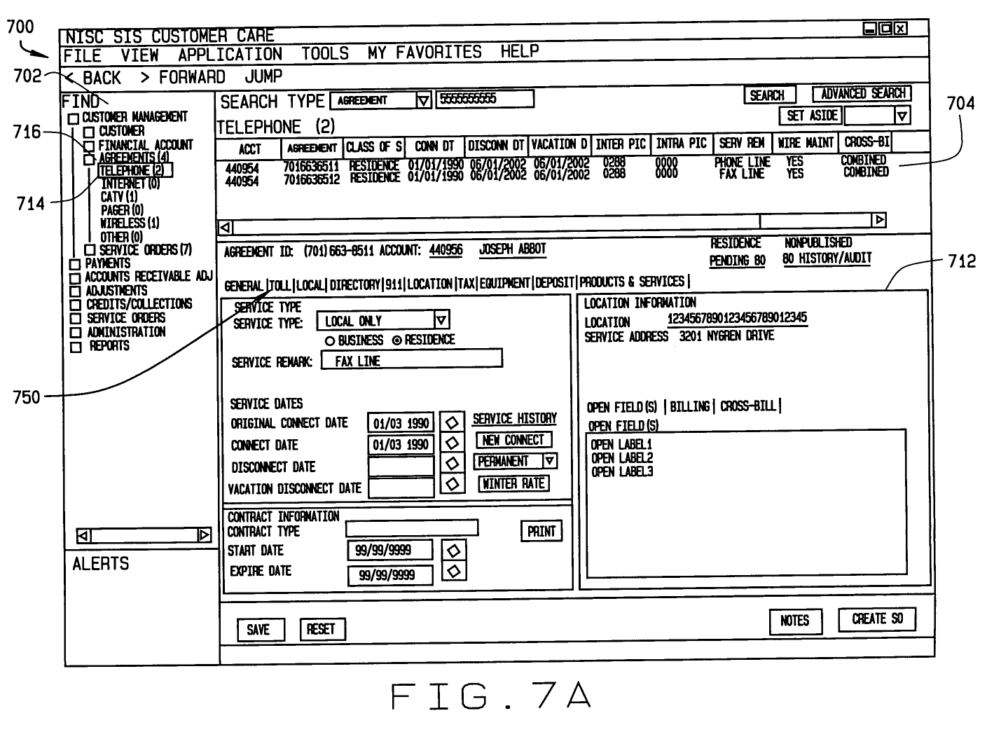

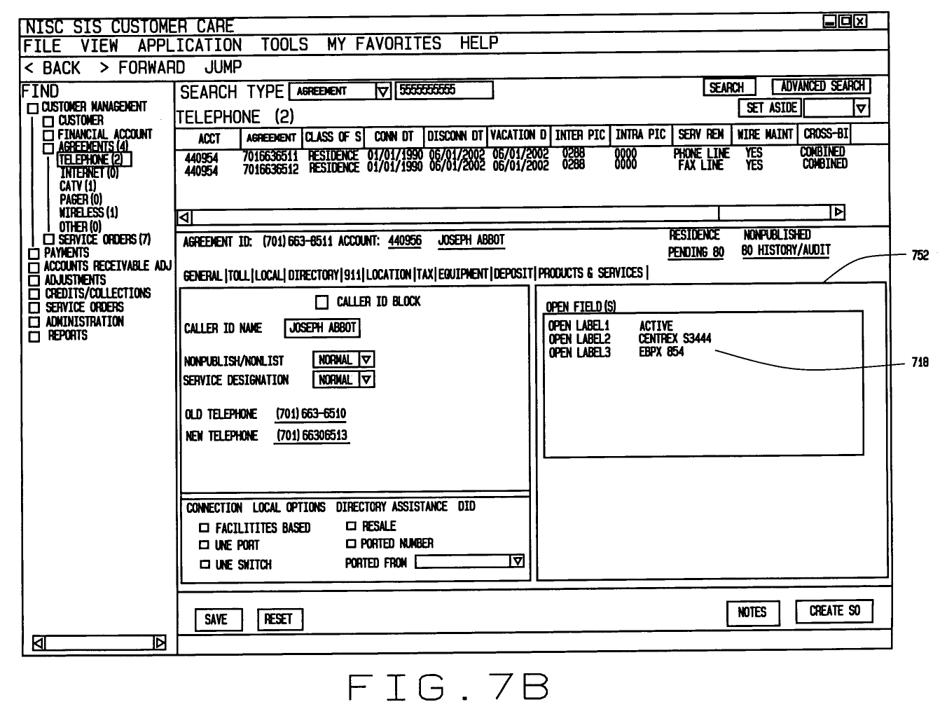

Referring to FIG. 7a, a basic sample screen is shown which reflects in the type of content that can be presented in the rich graphical user enterprise. In an exemplary display such as the one shown in FIG. 7a, a screen shot of a user interface that provides access to telephone service is shown and referenced as display 700. This type of graphical user interface could be provided to a customer service representative in the telecommunications industry utilizing the integrated frameworks. The display 700 can include a navigation window 702.

The display 700 illustrates the result of selecting the ‘telephone’ node 720 from the navigation window 702. It is noteworthy that within the same area of the navigation window 702, the ‘Agreements’ node 720; which is the parent of the telephone node indicates that there are four agreements associated with this particular customer. Specifically and as indicated by the appropriate agreement type, there are two telephone, one cable television and one wireless agreement. In other words, a Customer Service Representative (CSR) can tell at a glance how many agreements a particular customer has in addition to telling the types of agreements. When a particular agreement such as the telephone is selected, the summary area displays a table 704 and the content window 712 displays other fields and tabs that are relevant to a telephone type of service.

The table 704 contains two rows of fields summarizing the relevant information for each of the two indicated telephone agreements. Unless the CSR selects differently, the details associated with the first of the two entries in the summary table 704 can be displayed within the content window 712. The content window 712 also displays a number of tabs 714, which are specific to the type of service that has been selected by the CSR, for display. For example, because the current service type is telephone, there are tabs 714 for general information, toll, local, directory information, 911 information, location, tax, equipment, deposit and products. In other words, if the CSR had selected cable television, the displayed tabs 714 may be quite different. Each tab 714 provides quick access to other items of information that are related to the agreement type that is being viewed by the CSR.

For example, when a CSR selects the Local tab 714, having previously selected a service type of telephone, a new view 716 can be shown within the content window 712, as illustrated in FIG. 7a. The view 716 provides access to information and specific properties relating to local options for a telephone service such as, caller Id status, publication of the listing, the option to change the phone number and so on. The access and ability to modify the properties of a service require proper security. The view 716 may also include some user defined open fields 718 as shown, the concept of which was described earlier.

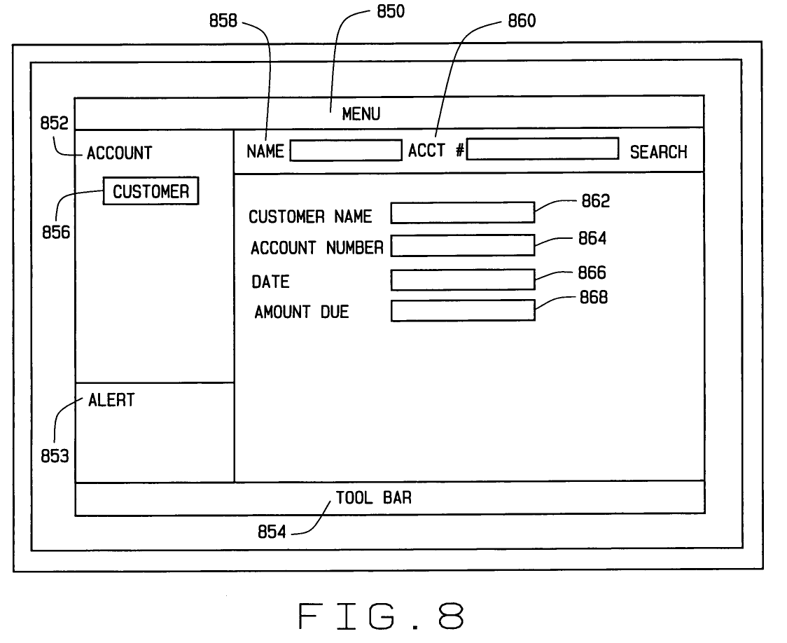

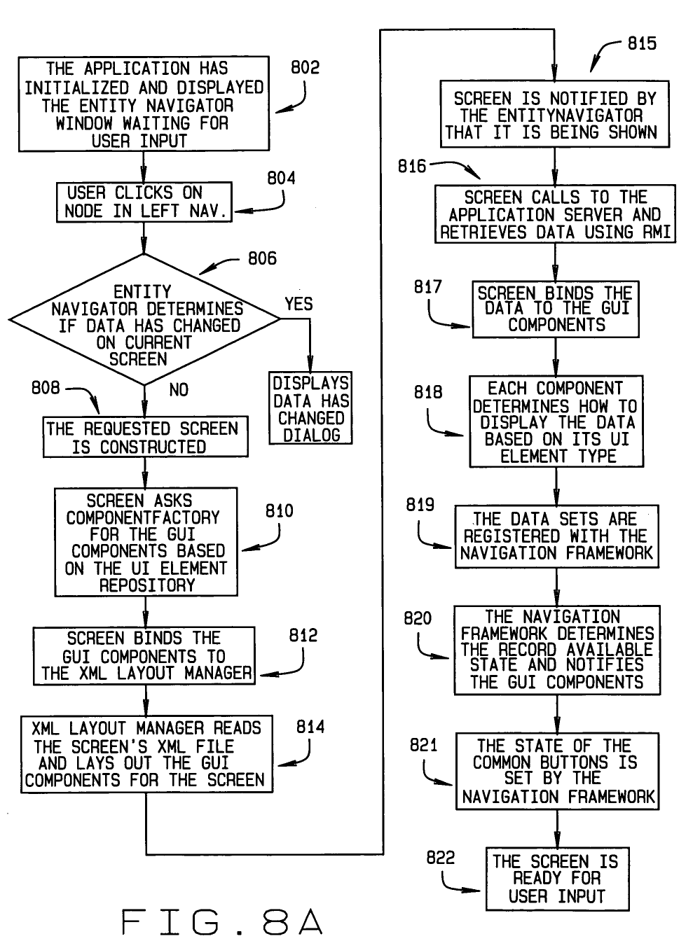

Referring back to FIGS. 6 and 6a, the flow diagram shown therein reflects the top level software application functional flow for generating the graphical user interface. However, referring to FIG. 8 and FIG. 8a, a flow diagram is shown for a screen build 8a and a basic example screen 8 is shown, which reflects operation at the screen level and the operation of the frameworks and repositories behind the scene. FIGS. 8 and 8a along with the following description presents an example of a basic screen that illustrates the use and operation of the repositories and frameworks. The example is for illustrative purposes only and is not intended in anyway to be limiting on the scope of the invention and is not intended as an all inclusive comprehensive example.

The flow diagram begins in a state where the application has been initialized and awaiting a user input as reflected by functional block 802. When the application is initialized only the basic screen information is displayed, refer to FIG. 8, such as the menu bar 850, the left navigation with only the account node 852 displayed, the alert window 853, and the tool bar 854. In order to present this basic user interface screen, starting at the left navigation level, there are, for example, three entries in the screen repository.

One entry in the screen repository would be the left navigation structure for the application, which would include the parent/child relationships between the nodes. The screen repository defines the hierarchical structure of the left navigation tree for an application and determines the Java class that will be constructed and executed when a node is selected in the tree. This allows the navigation of the application to be structured as needed by the designers and not hard-coded within the application. Search panels are associated to the screens within the repository so that the search panels can be developed independent of the screen, easily reused and changed. A NISC developed Java application is used to maintain the screen repository database tables. An XML file is created at build time from the database tables that is used by the navigation and security frameworks.

A second entry in the screen repository would be a folder or a child of the application that was initialized. In the present example the folder would be representative of the account node 852.

A third entry in the screen repository would be a child of the folder or leaf node, for example, the customer leaf node 856 as shown in FIG. 8. The above screen repository entries should define various attributes, which include parent/child relationships between the nodes, positioning information, and implementation information. The attributes would be exported from the screen repository at build time through XML to generate the left navigation.

The next functional block in FIG. 8a reflects a user screen selection functional block 804. The user could for example drill down through the left navigation to the customer leaf node 856 and select the customer leaf node 856 as shown in FIG. 8. The next functional block is a decision block that determines whether the data has changed on the current screen 806. The next functional step in the flow call for construction, functional block 808, of the requested screen. The screen repository framework requests a component factory to provide the GUI components 810 referencing and corresponding to the UI element repository framework. The screen repository framework binds the GUI components to the XML layout manager as shown by functional block 812. The XML layout manager reads the screen's XML file and lays out the GUI components for the screen as reflected by block 814.

The Screen Repository Framework is notified that the screen is being shown as reflected by functional block 815. The Screen repository framework calls the application server and retrieves data using RMI as reflected by functional block 816. The data binding repository framework binds that data to the GUI component as determined by the UI element repository framework and the screen repository framework as reflected by functional blocks 817 and 818. The UI element type determines how to display the data as reflected by functional block 818. The data set are registered with the navigation framework as reflected by functional block 819.

The navigation framework determines the record available state and notifies the UI components as reflected by functional block 820. The state of the common buttons is set by the navigation framework as reflected by functional block 821. The navigation framework controls the displaying of the screens within an application. It builds the left navigation tree structure based on the screen repository XML file. The framework allows for quick jumping between screens and controls the displaying of screens within the application's entity navigator window or within a dialog. The framework controls the state of the common buttons, which provides for consistent behavior between screens. This framework also controls the screen state that indicates if there is data available to display by the GUI components. The GUI components are notified of the screen state and their display states are set accordingly. The screen is again ready for user input.

When the customer leaf node is selected in the example, the search window is populated with two graphical user interface fields, “name” 858 and “acct#” 860, as shown in FIG. 8. The content window is populated once a customer name or customer number has been entered with four graphical user interface fields, “customer name” 862, “account number” 864, “Date” 866, and “amount due” 868. In order to construct this screen containing these elements, the screen repository framework requests the component factory for the GUI components based on the UI element repository. The screen framework binds the GUI component to the XML layout manager. The user is prompted to enter a customer name or account number and click the search button to initiate a search for data and population of the fields. The user should then type in a name or account number and click the search button. The content area is then populated with the graphical use interface fields containing data. This is accomplished by the screen repository framework binding the GUI component to the XML layout manager. The XML layout manager reads the screen's XML file and lays out the GUI components for the screen. The screen framework calls the application server and retrieves data using RMI. The screen binds the data to the GUI components. Each component determines how to display the data based on the UI element type.

At the UI element level, the four graphical user interface elements displayed (name, acct, date, and amt. due) should be defined as UI elements. The UI elements could be either ‘temp’ type information or be related to a database. For this example, we will assume, it is related to a database. The naming of the element should differ for ‘temp’ type or related to a database type. The four elements can already exist in the UI repository and are subject to reuse, or they can be created in the case of a ‘temp’ type. The elements in the UI repository should have the following elements: ‘element name’ (for example—ccCustName, ccAcctNum, ccDate, and ccAmtDue); ‘label’ (for example—Customer Name, Account Number, Date, and Amount Due); ‘logical type’ (for example—string, integer, date, and currency); ‘length’, ‘help’, ‘value’, ‘pattern, and etc. . . . The element definitions are exported via XML.

The logical type referred to in the UI repository relates to a data type and the characteristics of the data type. There is a table in the UI repository that controls behavior, validation and attributes. Within the logical type table there is a definition of length, mask, physical type and validation that is indicated. Using the example outlined above for illustrative purposes, to define the logical types used above would be as follows:
Logical Type=Currency (for ‘Amount Due’)
Controlled by java=Y (means that a java class is running behind the scenes each time an element is used w/ this logical type. This java class is controlling field level validations, cursor movement, etc.)
Physical Type=Double—one of the supported java types.
Mask=$9,999,999.00—this establishes a default size for currency related amounts
Allow Override=Y (means that a developer can opt to make the field smaller or larger in their specific screen instance)
Pattern=used to control values, not used in this case
Logical Type=String (for ‘Customer Name’)
Controlled by java=N
Physical Type=String—one of the supported java types.
Mask=typically NOT used for string types
Length=5, assumed default for string types.
Allow Override=Y
Pattern=used to control values, not used in this case
Logical Type=Date (for ‘Date’)
Controlled by java=Y (means that a java class is running behind the scenes each time an element is used w/ this logical type. This java class is controlling field level validations, cursor movement, etc. Controls valid year and valid date info)
Physical Type=Date—one of the supported java types.
Mask=99/99/9999
Allow Override=N (means that a developer CANNOT opt to make the field smaller or larger in their specific screen instance)
Pattern=used to control values, not used in this case
Logical Type=Integer (for ‘Account Number’)
Controlled by java=N
Physical Type=Integer—one of the supported java types.
Mask=99999999
Length=not used for numeric values
Allow Override=Y—developers can decrease this length as needed.
Pattern=used to control values, not used in this case

If there is nothing unique about the instance and implementation of the fields as they are used by the leaf node ‘customer’, the UI repository elements would essentially comprise the attributes outlined above. The UI elements can then be referred to in the GUI JAVA code, which implements the graphical user interface functionality, refer to functional blocks 606-614 of FIG. 6.

The UI element repository defines how the data-binding framework will handle the data and how the data will be displayed on the screen by the GUI components. Labels, tool tips, one line help, etc. are types of information that is contained in this repository. Data types, i.e. date, currency, text, etc., are defined and associated to elements. An element represents a piece of data that is used by the application. The data types dictate the acceptable data that can be entered into the GUI components. Display attributes control how the data is displayed within the GUI component. A NISC developed Java application is used to maintain the UI element repository database tables. An XML file is created at build time from the database tables, which is used by the data binding and GUI frameworks.

The data-binding framework binds data received from the application server to UI elements and GUI components. The application developer binds a GUI component to a UI element contained within a data set. This binding provides for communication between the data sets and the GUI components. This communication keeps the two synchronized so as the user enters new data into a GUI component the associated data set is updated. Also, as a data set is changed via the application the GUI components will be updated.

The GUI framework controls how data is displayed and processed within a GUI component. A GUI component is bound to an element from the UI element repository, which dictates the type of data allowed and how the data will be displayed. The GUI component is bound to a data set using the data-binding framework to control how the data is set upon the component and how the data set is updated by the component. An XML layout manager determines the screen layout definition from an XML file instead of hard-coding the layout within the Java class. This allows for dynamic changes by the application developer to the screen layout as the application is running to provide the ability to fine-tune the placement of the GUI components on the screen.

If a unique implementation of the UI element implementation is required by the leaf node selected by the user, a joined table in the UI Screen Repository may be created. The table would comprise specific instances of a leaf node (or dialog or tab) and the specific UI elements called by the leaf node that perform differently than the norm. Therefore, if it is desired to have a unique implementation of a UI element for a leaf node, entries would be made to the UI Screen Repository that would provide the global unique identifier assigned to the leaf node screen, the UI element name, and the changed attribute. For example, the leaf node ‘customer’ identified in the example outlined above, could have a joined table comprising a global identifier ‘123456’ for the leaf node, the element name for the element to be uniquely implements, and the unique attribute.

Once the Screen Framework binds the GUI component to the XML layout manager and the layout manager lays out the components on the screen and the data is retrieved and bound to the GUI component, the GUI framework controls how the data is displayed based on the UI Element logical type. The graphical user interface screen is then displayed and ready for another user selection or data entry.

The primary advantage of the frameworks is to reduce the coding complexity for application developers when writing distributed Java applications using a sophisticated graphical user interface. The application developer does not need to write the tedious and error-prone code of handling data received from the application server and appropriately displaying the data on the screen. Security issues are handled automatically, i.e. screens disappear from the left navigation tree structure, buttons disable, etc., without the application programmer having to code anything. Most data updating and GUI event handling is accomplished by the frameworks requiring considerably less code per screen. The GUI components handle the proper displaying of data based on the properties in the UI element repository and only accept the proper data based on the element's type saving considerable coding by the application developer. These frameworks provide for consistent behavior with considerably less errors and significantly less code to develop an application. The integrated system of frameworks reduces the time it takes to develop applications which provide such a graphical user interface.

The various framework and repository examples shown above illustrate a novel method and apparatus for integrating data repositories and frameworks to create a robust graphical user interface. A user of the present invention may choose any of the above integrated framework embodiments, or an equivalent thereof, depending upon the desired application. In this regard, it is recognized that various forms of the subject method for integrating frameworks could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawings, the disclosure and the appended claims.

1. An integrated system of frameworks and data repositories for generating a graphical user interface in a client-server environment comprising:
a user interface (UI) repository residing in a database accessible to a client server network environment, where said UI repository, contains a UI element, which defines data element attributes including data type, how to display data and labels;
a screen repository residing in the database accessible to the client-server network environment, where said screen repository includes screen attributes, which defines the hierarchical navigational tree structure of screens for an graphical user interface (GUI) application and further defines what screen will be constructed and defines a GUI component of the screen;
a data binding framework operable to bind data to the UI element and the GUI component;
a (GUI) framework operably residing at a client in the client-server network environment, where said (GUI) framework is operable to control how data is handled and processed within the GUI component of the GUI application including binding data to the GUI component utilizing the data binding framework; and
a navigation framework operably residing at the client, where said navigation framework controls generating and displaying of the screens within an application and further builds a navigation tree structure based on the screen attributes.

2. The integrated system of frameworks and data repositories for generating a graphical user interface as recited in claim 1, further comprising:
a security framework operable to communicate information to the navigation framework causing the navigation framework to selectively deny a user access to screens by not providing the user with selections that would navigate to the screen.

3. The integrated system of frameworks and data repositories for generating a graphical user interface as recited in claim 1, further comprising:
a verification framework operable to apply business rules to data contained in a data set and determine if the data is in error and if in error the verification framework communicates with the GUI component to display an error message.

4. An integrated system of frameworks and data repositories for generating a graphical user interface in a client-server environment comprising:
a graphical user interface (GUI) framework operably residing at a client in a client-server network environment, where said GUI framework is operable to control how data is handled and processed within a GUI component of a GUI application including binding data to the GUI component utilizing a data binding framework;
a collection of integrated repositories relationally inter referenced by elements within their respective attribute tables operable for accessing and integrating all attribute elements relating to generating a graphical user interface;
a collection of executable object oriented routines operable to manipulate the GUI framework;
a collection of XML files operable to access and export data from the repositories at run time for use by the GUI application;
an XML layout manager operable to define the screen layout from the collection of XML files; and
a navigation framework operably residing at the client, where said navigation framework controls generating and displaying of screens within the GUI application based upon the XML lay out manager and the repository attributes accessed and exported by the collection of XML files and further builds the navigation tree structure based on the repository attributes.

5. The integrated system of frameworks and data repositories for generating a graphical user interface as recited in claim 4, further comprising:
a security framework operable to communicate information to the navigation framework causing the navigation framework to selectively deny a user access to screens by not providing the user with selections that would navigate to the screen.

6. The integrated system of frameworks and data repositories for generating a graphical user interface as recited in claim 4, further comprising:
a verification framework operable to apply business rules to data contained in a data set and determine if the data is in error and if in error the verification framework communicates with the GUI component to display an error message.

7. An integrated system of frameworks and data repositories for generating a graphical user interface in a client-server environment comprising:
a screen repository residing in the database accessible by a client-server network environment, where said screen repository includes screen attributes, which defines the hierarchical navigational tree structure of screens for an graphical user interface (GUI) application and further defines what screen will be constructed and defines a GUI components of the screen;
a user interface (UI) repository residing in a database accessible to the client server network environment, where said UI repository, contains a UI element, which defines data element attributes including data type, how to display data and labels; and
a data binding framework operable to bind data to the UI element and the GUI component based on the data type defined in the UI repository.

8. The integrated system of frameworks and data repositories for generating a graphical user interface as recited in claim 7, further comprising:
a security framework operable to communicate information to the navigation framework causing the navigation framework to selectively deny a user access to screens by not providing the user with selections that would navigate to the screen.

9. The integrated system of frameworks and data repositories for generating a graphical user interface as recited in claim 7, further comprising:
a verification framework operable to apply business rules to data contained in a data set and determine if the data is in error and if in error the verification framework communicates with the GUI component to display an error message.

10. An integrated system tool for building of frameworks and data repositories for generating a graphical us interface comprising:
an administrative computing tool including,
a navigation tool for building a navigation framework adapted to control the generation of screens for a graphical user interface (GUI) application and further adapted to define the hierarchical relationship of the screens,
a screen repository tool operable to build a repository of screen attributes to establish a hierarchical screen navigation structure and a corresponding Java class construct to be executed and a GUI component,
a user interface repository tool operable to build a user interface repository having user interface attribute tables of user interface elements corresponding to the GUI component, and
a data binding framework tool operable to build a data binding framework operable to bind data from an appropriate data set to the user interface element and the GUI component.

11. The integrated system tool for building frameworks as recited in claim 10, where the administrator computing tool further comprises:
a security framework tool operable to build a security framework operable to communicate information to the navigation framework causing the navigation framework to selectively deny a user access to screens by not providing the user with selections that would navigate to the screen.

12. The integrated system tool for building frameworks as recited in claim 10, where the administrator computing tool further comprises:
a verification framework tool operable to build a verification framework operable to apply business rules to data contained in a data set and determine if the data is in error and if in error the verification framework communicates with the GUI component to display an error message.

13. A method of generating a graphical user interface utilizing an integrated system of frameworks and data repositories comprising the steps of:
Receiving a screen request to a graphical user interface (GUI) application based on a user input;
Accessing and constructing a basic screen and screen attributes from a screen repository corresponding to the user input as determined by a navigation framework;
Binding GUI components defined by the screen attributes with user interface elements from a UI repository based on the attributes defined in the UI repository;
Binding data to the GUI components and UI elements; and
Displaying the screen.

14. The method of generating a graphical user interface as recited in claim 13, further comprising:
filtering a screen with a security framework operable to communicate information to the navigation framework causing the navigation framework to selectively deny a user access to screens by not providing the user with selections that would navigate to the screen.

15. The method of generating a graphical user interface as recited in claim 13, further comprising:
displaying an error message with a verification framework operable to apply business rules to data contained in a data set and determine if the data is in error and if in error the verification framework communicates with the GUI component to display an error message.

16. A method for building an integrated system of frameworks and data repositories for generating a graphical user interface comprising the steps of:
building a graphical user interface (GUI) framework operable to reside at a client in a client-server network environment, where said GUI framework is operable to control how data is handled and processed within a GUI component of a GUI application including binding data to the GUI component utilizing a data binding framework; and
building a collection of integrated repositories to be relationally inter referenced by elements within their respective attribute tables operable for accessing and integrating all attribute elements relating to generating a graphical user interface.

17. The method for building an integrated system of frameworks and data repositories as recited in claim 16 further comprising the steps of:
building a verification framework operable to apply business rules to data contained in a data set and determine if the data is in error and if in error the verification framework communicates with the GUI component to display an error message.

18. The method for building an integrated system of frameworks and data repositories as recited in claim 16 further comprising the steps of:
building a verification framework operable to apply business rules to data contained in a data set and determine if the data is in error and if in error the verification framework communicates with the GUI component to display an error message.
